(19) United States
(12) Patent Application Publication
(10) Pub. No.: US 2009/0254495 A1
(43) Pub. Date: Oct. 8, 2009

(54) SERVICE LEAP

(76) Inventors: Meera Patwardhan, Mumbai (IN); Hamsini Shivakumar, Mumbai (IN)

Correspondence Address: MEERA PATWARDHAN;5 Garden Homes - 1st floor, Khar Danda Road - near 21st Road, MUMBAI, MA, 400052, IN

(21) Appl. No.: 12/098,501

(22) Filed: Apr. 7, 2008

(51) Int. Cl. G06Q 90/00

(52) U.S. Cl. 705/500

(57) ABSTRACT

The Service Leap comprises of a system and method that provides a systematic process and tools for branding of existing and potential services with a view to increase their appeal to customers and their market value. The invention provides for creating branded services through a bottom up approach starting from every ‘touch point’ at which the service interacts with consumers and accomplishes the same through several process steps viz. customer journey map, brand star, brand house and communication house. It is specially developed to deal with the unique nature of service businesses unlike existing positioning models that are suited only for products.

### FIELD OF THE INVENTION

The present invention relates in general to marketing services and more particularly relates to to creating, implementing, and managing a system and method for evaluating the value of the branded services in which the availability of new interactive services are indicated.

### BACKGROUND OF THE INVENTION

From an historical perspective, services always developed in civilizations before products did. Then came the industrial revolution and products dominated the marketplace. However, history is famous for repeating itself and therefore in the new economy, services have begun to reclaim their share of the consumer's money once again. However, this reinvention and resurrection of the service economy has not been supported adequately by theoretical studies on service marketing. This is because the majority of marketing literature post the industrial revolution was dedicated towards marketing of products. Due to lack of adequate academic information on the subject, service marketers have had to face many challenges in the marketplace, unguided.

Brand equity is a significant contributor to the financial value of most successful firms. Brand equity represents the value inherent in the ability of a firm's brands to command premium prices for goods and services. The premium prices that customers are willing to pay for branded goods and services as compared to identical non-branded goods and services, and the incremental demand that strong brands generate can account for more than half the value of a firm. Growing brand equity requires strong brand identity—the meaning of the brand in the minds of targeted customers.

Services are very different from products and therefore need a different approach for branding. Services are intangible (you cannot ‘see’ or ‘touch’ a service, you can only experience it). Services are usually delivered through people and therefore it is hard to standardize and ensure consistent delivery, every time. Thus customers are more involved in evaluating services and evaluate them far more critically than they would products. Furthermore, in service businesses, it is easy for competition to duplicate new features, making it harder to differentiate services.

The plethora of ‘tried and tested’ branding and positioning models available today (E.g. Brand Key and Brand Tree) were designed keeping in mind products and not services. Yet, service marketers have to apply them as they are the only models available/familiar to them. In our opinion these models are inadequate to deal with the complex nature of services and do not provide service marketers with the canvas needed to differentiate their service from competition—and unless powerful differentiation is possible, services cannot become strong ‘brands’.

The lack of an appropriate branding approach tailored to the requirement of service businesses prevents them from realizing the real ‘value “that powerful branding can bring them. Furthermore, customers too are at the receiving end of poor/uneven quality of services which do not live up to the claims advertised by these marketers.

The relevant prior art methods, which deal with existing positioning models for branding products are as follows:

US Patent Application NO. 20070061199 explains about a system and method for creating, implementing, managing and analyzing various elements of a strategy for creating customer or audience intimacy with a brand, including but not limited to an individual, concept, group or other entity. One exemplary embodiment includes, but is not limited to, a set of tools for building and managing an online community entered on the brand or entity. These tools include a plurality of databases; a plurality of customizable website content-management modules; webmail and email-tracking services; additional tracking methods for a variety of marketing campaigns and events; client administration modules; and sales and accounting modules.

US Patent Application NO. 20070260521 disclose an interactive marketing communication and transaction services platform for managing personalized customer relationships. The platform facilitates communication and transactions between consumers, retailers and manufacturers, by helping suppliers customize product/service offerings, presentations and advertising messages to reflect individual consumers' needs, while providing portals with premium advertising messages for personal interactive info/news/entertainment services. The core of the platform consists of i) a central database system with ‘product/retail information’ and ‘holistic purchase-behavior specific consumer profiles’, generated by registering online product/retail information retrieved by consumers, as well as purchases made both on-line and in-store, using a loyalty card; ii) software applications, that create ‘market intelligence’ on manufacturer/retailer offers, consumer purchase needs, market performance of products/retailers and impact of brand/retailer presentations and ads on consumer purchase behavior; and iii) standard performance indicators, that make it possible to benchmark individual consumer communication programs against each other.

US Patent Application NO. 20030093331 reveals about a method, software and apparatus are provided which enable a merchant to promote products and services in a deterministic manner. When a shopper enters a set of key words in an entry in an on-screen form for a web server to obtain a list of items (products and/or services) of interest to the shopper, the documents describing the items are prioritized based on the web sites owner's organizational strategic decisions by the merchant providing a weighting factor for the products and services. The weighting factor is combined with existing ranking mechanisms to the documents to increase the probability that certain items come to the top when the search results are presented to the shopper. These items could be used to ensure shoppers do not overlook special offers or to reduce overstocks by promoting products with a large inventory. The weighting factor is configured so as to not decrease the shoppers confidence in the ranking process.

US Patent Application NO. 20070250484 describe a perception research system and method is configured to combine aspects of both quantitative research and qualitative research. The perception research system includes a user interface that allows users to interact with the system based in part on the graphical nature of the user interface to form qualitative associations between various concepts expressed through image cards, text cards, ranking inputs, and group icons. The system allows for record capture of statistics associated with the qualitative associations expressed by users through their interaction with the system to allow for later quantitative analysis of the expressed qualitative associations. By combining the quantitative and qualitative research worlds, the system offers a way to develop, test, and validate understanding of perceptions of humans such as involving consumer perceptions of new products, branding strategies, and other creative concepts using ethnographic and other methodologies combined with statistical expression of such.

US Patent Application NO. 20020082989 describes a system and method for presentation of feedback cues to a user of an interactive payment system is disclosed, wherein in one application, a payment product logo is displayed substantially concurrent with user entry of a payment product identifier, such as a credit card number. The subject invention further provides for the reduction of user confusion and errors with respect to entry of information related to a payment transaction. Moreover, the invention provides for reinforcement of payment product and/or service loyalty and branding.

US Patent Application NO. 20060020506 disclose that documents or document sets may be scored to reflect a value of an action, such as a selection for example, when an ad is served with the document (or a document belonging to a document set). A number of ads to be served with a document, and/or a type or level of branding to be provided to such ads, may then be controlled using the score. Document scores used in this way may help the ad serving system maintain and manage the quality of its brand. Further, a number of ads to be served, and/or a type or level of branding to be provided to such ads may be controlled using other factors that may affect end user perceptions of the quality of ads.

US Patent Application NO. 20050216346 explains that participants in an interactive environment implemented by computer networks and other media such as interactive television are recruited to advertise products and brands to the other participants and viewers that are users of the media. Each participant may select from a set of available advertisements, which can be displayed in association with the user's avatar, virtual space and virtual objects within or embodying the virtual world. Participants are given incentives to do this by the availability of rewards, such as coupons, real or virtual money or other resources, which are provided by the advertising sponsors, based on adoption of the advertising by the participant, as well as on factors such as exposure of the selected advertisements to other users. Allowing the users to exercise advertising choice, as participant or viewer, the invention also facilitates collection of data regarding consumer preferences.

US Patent Application NO. 20050050320 describes about a branding framework for use in efficiently locating branding resources and applying them throughout a software product. Centrally stored resource files contain branding resources and have namespaces assigned to them. A branding engine of the framework calls a group of resource files as a function of a selected namespace and searches the called group for branding resources to be installed in the software product. In one embodiment, the branding engine searches the called resource files based on the metadata embedded in the resource files.

However the purpose and methodology of the above inventions that are part of prior art do not address the core marketing issue of how to go about building a powerful, valuable service brand. They also do not provide the steps and tools to go about the same. The present invention differs from the existent prior art in that it uses customer journey map, brand star, brand house and communication house. All these process steps are applicable to both existing and potential services whereby the framework is designed to build a service ‘bottom up’ starting from every ‘touch point’ at which the service interacts with consumers.

The framework further provides more than just a model where the entire process can be practically implemented by a service business.

It will be apparent to those skilled in the art that the objects of this invention have been achieved by providing service branding framework which is unique in nature of service businesses unlike existing positioning models that are suited only for products. Various changes may be made in and without departing from the concept of the invention. Further, features of some stages disclosed in this application may be employed with features of other stages. Therefore, the scope of the invention is to be determined by the terminology of the following claims and the legal equivalents thereof.

### SUMMARY OF THE INVENTION

This invention may be summarized, at least in part, with reference to its objects.

The primary object of this invention is to provide a systematic process and tools for branding of existing and potential services with a view to increase their appeal to customers and their market value.

Therefore it is an object of the present invention to evaluate the quality of service offered to consumers and enhance it, thereby providing customers with a better service experience and guarantee of consistent quality and reliability of the service

It is another object of the present invention to design branded services keeping in mind desires and expectation of consumers and therefore provide services that are convenient, time-saving and provide value for money from the consumer's perspective.

It is another object of the present invention to ensure that branded service actually delivers to consumers, what is claimed or promised through advertising and other communication routes, thereby reducing the gap between claimed and actual service quality and enabling consumers to reduce perceived risk in buying of services.

These and other objects of the present invention will be more readily apparent when considered in reference to the following description and when taken in conjunction with the accompanying drawings.

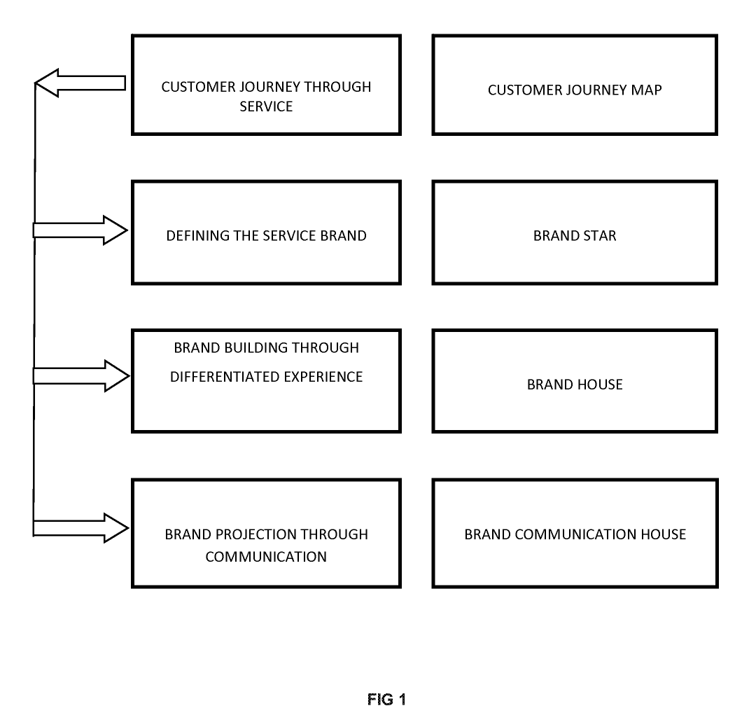

FIG. 1 is a flow diagram containing the list of various stages and steps that a user has to go through in using the invention

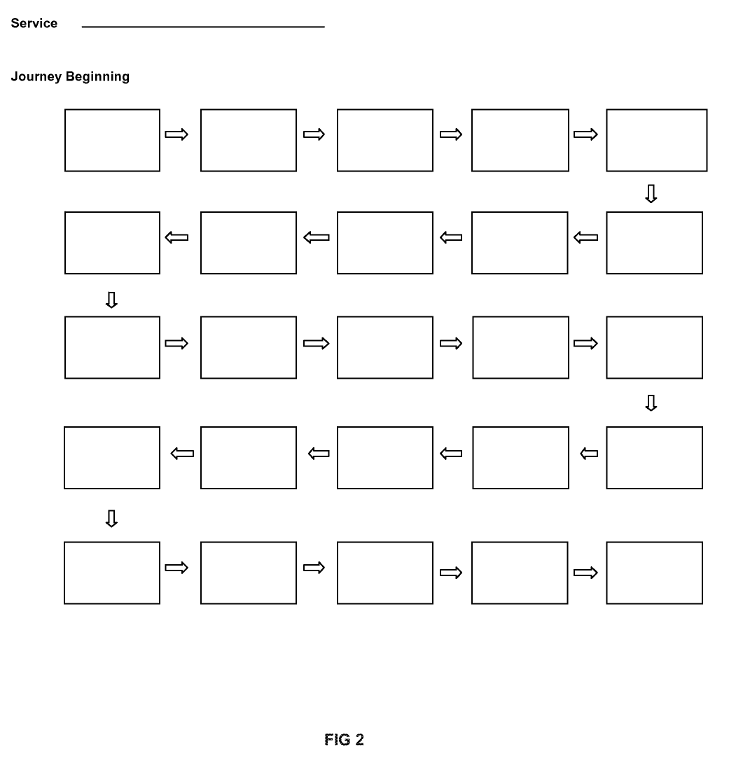

FIG. 2 is a flow diagram containing an exhaustive list of the steps and stages that customers has to pass through when experiencing the service

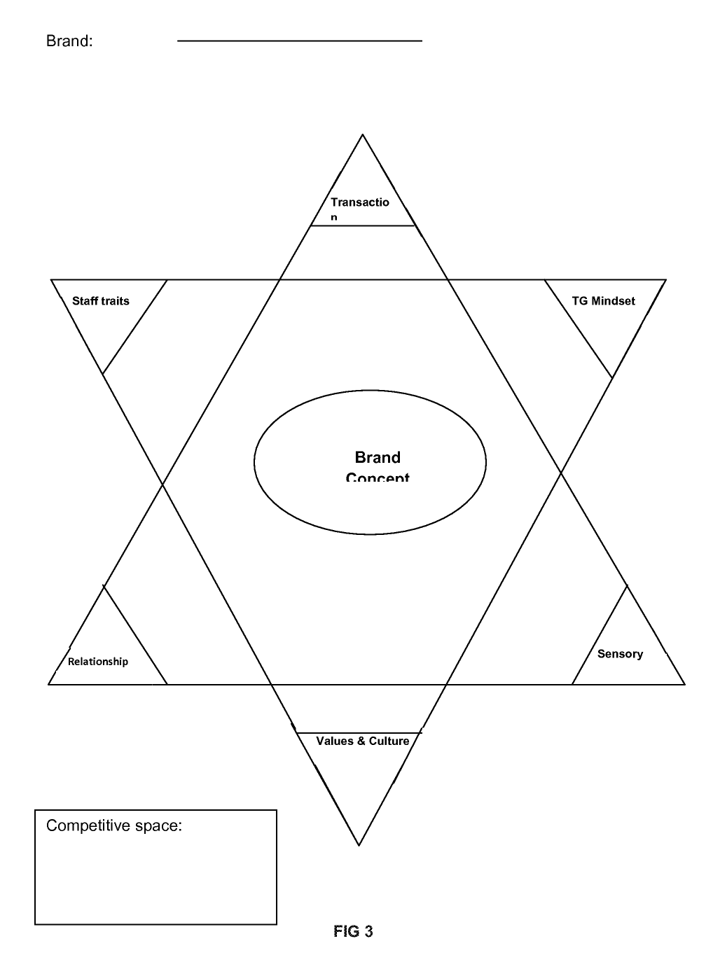

FIG. 3 is a flow diagram containing a framework which shows the positioning of the service brand.

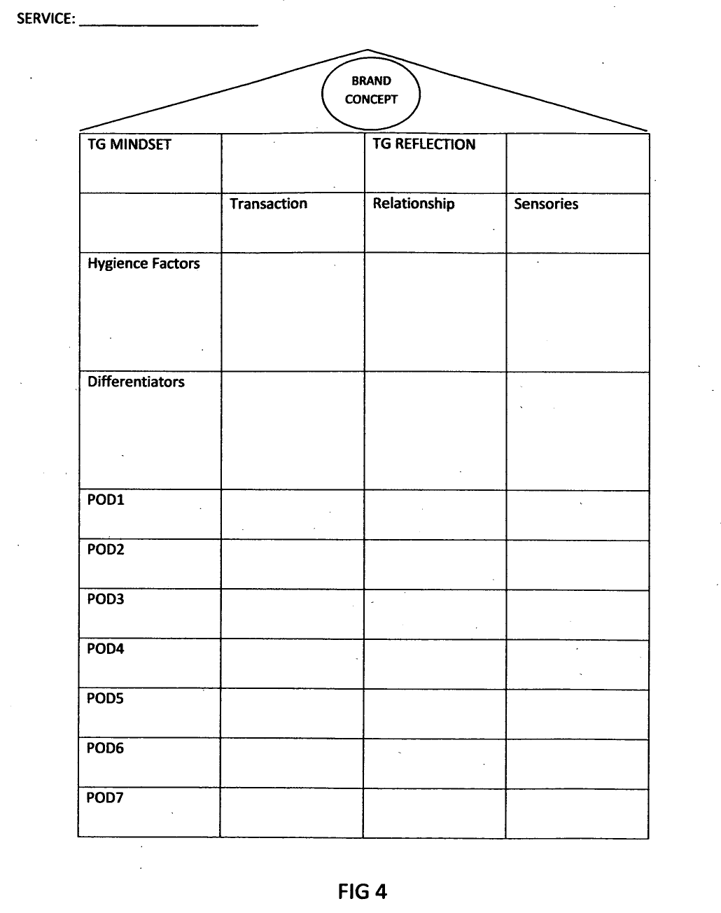

FIG. 4 is a tabular diagram containing a tool to map and classify the PODs derived from the Customer Journey Map.

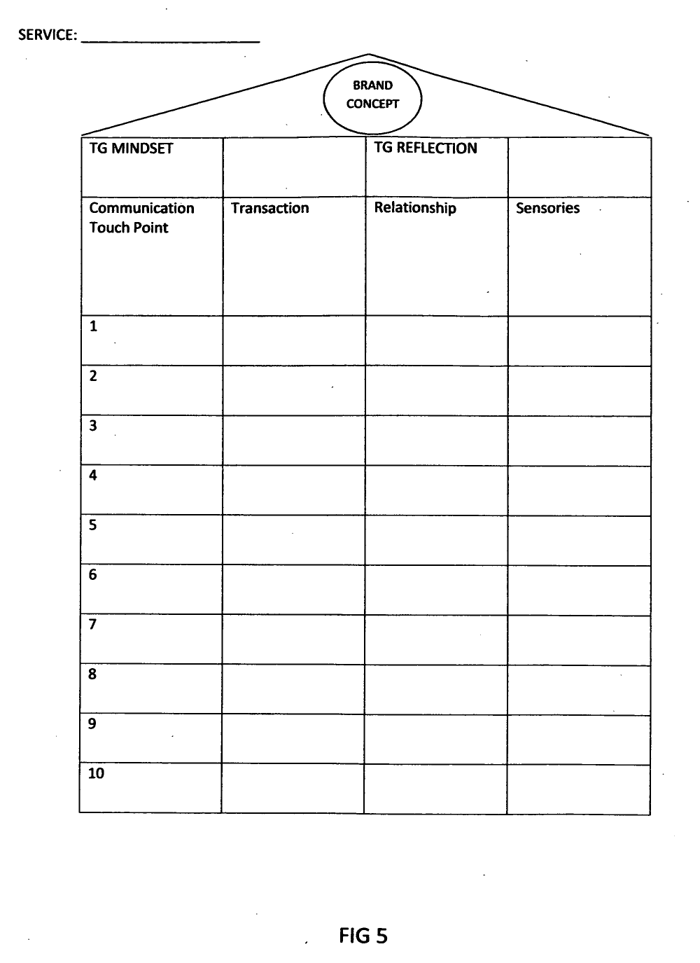

FIG. 5 a tabular diagram containing a framework which is used to plan the communication (advertising, promotion, public relations etc) as part of the brand building process

### DETAILED DESCRIPTION OF THE INVENTION:

The present invention may involve novel methods, message formats, data structures etc to implement the said invention. The following description is presented to enable any person skilled in the art to make and use the invention, and is provided in the context of particular applications of the invention and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of processes may be described with reference to a flow diagram, the order of processes may differ in other implementations when the performance of one processes is not dependent on the completion of another processes. Further, non-dependent processes may be performed in parallel. Thus, the present invention is not intended to be limited to the embodiments shown and can be configured as follows:

The service leap is specially developed to deal with the unique nature of service businesses unlike positioning models that are suited only for products. It encompasses much more than just a brand positioning for communication. The framework is designed to build a service ‘bottom up’ starting from every ‘touch point’ at which the service interacts with consumers. Therefore it is a highly detailed and meticulous approach. Current models tend to focus differentiating through communication/advertising message. Communication-led positioning does not suffice to differentiate services from competition since consumers differentiate services through their ‘experience’ of them rather advertising (e.g. Pepsi and Coke may taste fairly similar so you may differentiate them through their ads, but consumers would tell the difference between two airlines that you've flown based on the difference in the quality of service that each offers)

Similarly the framework of the invention provides more than just a theoretical model and it is an entire process that can be practically implemented by a service business across its back-end (operations and systems), customer-facing staff and other functions that impact service delivery. It does not just address the marketing function but provides for action by the entire organization including the disciplines and functions that actually design and deliver the service. Since it integrates implementation, it becomes a far more powerful model than the existing ones.

Every service can be mapped in terms of the sequential steps in the process as detailed in FIG. 1. Service businesses themselves map and flowchart their customer processes. The Customer Journey Map uniquely consists of the steps/stages in the process as seen, felt and described by consumers themselves. The present invention applies a Customer Journey Map wherein a special market research exercise is undertaken. Individual consumers are interviewed through in-depth interviews where they are asked to ‘walk through’ their experience of the service and recall it anecdotally in as much detail as possible, with high points, low points and anything that stood out for them. The experiences of different consumers are combined to construct the map.

The first embodiment of the present invention is therefore the Customer Journey Map as detailed in FIG. 2, which is an exhaustive list of the steps/stages that customers pass through when experiencing the service. Based on consumer evidence, we distil the customer journey further into ‘points of delivery (PODs). PODs are the few critical moments in the service experience that stand out in consumers' minds and impact the impressions that they form about the service—“we call them the ‘moments of truth”’. PODs represent the points in the service that is to be concentrated on—for improvement of the service, for creation of new services and for positioning and communication. Further, every point of delivery has three dimensions a. Transaction—the function/task that is being performed b. Relationship—how the customer relates to the people performing the service/to other users of the service c. Sensory—how the customer relates to the service with his senses (ex. The ambience sounds etc.)

The second embodiment of the branding services is the Brand Star Framework as detailed in FIG. 3 which is used for positioning of a service brand. The positioning is summed up in a ‘brand concept’ which is a one-line summary capturing the essence of what differentiates the service. The brand star anchors the positioning on multiple dimensions to ensure a differentiated brand, namely a) The competitive context in which the service is being delivered, b) The target audience and their mindset, c) The transaction, relationship and sensory dimensions which together constitute the service experience—the brand star captures the way in which these 3 dimensions will be different from competition in the way we deliver the service on-ground, d) The values and culture of the company that will also rub-off on the way the service is delivered, e) The staff traits of the people who are actually delivering the service (front-line staff) By detailing the above, it ensures that the brand concept actually gets translated into both tangible delivery in the service, and into ‘softer’ factors that actually influence the way the service looks and feels.

The next embodiment of the present invention is the Brand House as detailed in FIG. 4, which breaks up each POD into three dimensions (transaction, relationship, sensory) in order to understand which aspect of the above needs to be changed/enhanced. It also enables us to identify hygiene factors and differentiators for the service. The Brand House is a tool to map and classify the PODs derived from the Customer Journey Map. The Brand House provides the ground work required for branding of the service bottom up.

The further embodiment of the invention provides the Communication House as detailed in FIG. 5, whereby the framework is used to plan the communication (advertising, promotion, public relations etc) as part of the brand building process The Communication House defines what aspect of the service is to be communicated through different communication media and therefore forms the basis for Communication Planning for the service brand.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. The Service Leap comprising a system and method consisting of several stages for providing services and branding existing and potential services characterized in that the stages such as customer journey nap, brand star, brand house and communication house provide a systematic process and tools for branding of existing and potential services with a view to increase their appeal to customers and their market value.

2. The service leap as claimed in claim 1 wherein branded services are created through a bottom up approach starting from every ‘touch point’ at which the said service interacts with consumers.

3. The service leap as claimed in claim 1 wherein branding tools are used to deal with the unique nature of each of the said services.

4. The service leap as claimed in claim 1 wherein service businesses themselves map and flowchart their customer processes consisting of the steps and stages in the process as seen, felt and described by consumers themselves.

5. The service leap as claimed in claim 1 wherein every said service can be mapped in terms of the sequential steps in the process.

6. The service leap as claimed in claim 1 and 5, wherein a special market research exercise is undertaken and based on consumer evidence the service experience translated into a Customer Journey Map and further distilled in Points of Delivery that encapsulate the key aspects of the brand recognition.

7. The service leap as claimed in claim 1 and 5, wherein the Brand Star framework is used for positioning of a service brand.

8. The service leap as claimed in claim 7, wherein the said Brand Star frameworks gets translated in the translation of the said service brand into tangible delivery and into other factors that influence the way the service looks and feels.

9. The service leap as claimed in claim 1 and 5, wherein the Brand House Tool is applied to map and classify the points of delivery derived from the said Customer Journey Map.

10. The service leap as claimed in claim 9, wherein the said Brand House Tool breaks up each said point of delivery into the three dimensions of relationship, transaction and sensory, and provides the ground work required for branding of the said service bottom up.

11. The service leap as claimed in claim 1 and 5, wherein the Communication House is a frame work used to plan the communication as part of the brand building process.
